(19) United States
(12) Patent Application Publication
(10) Pub. No.: US 2010/0209303 A1
(43) Pub. Date: Aug. 19, 2010

(54) Pipette Device and Method of Manufacture and Use Thereof

(76) Inventor: Jun Tao, Mesa, AZ (US)

Correspondence Address: SUTHERLAND ASBILL & BRENNAN LLP, 999 PEACHTREE STREET, N.E., ATLANTA, GA, 30309, US

(21) Appl. No.: 12/707,992

(22) Filed: Feb. 18, 2010

Related U.S. Application Data
(60) Provisional application No. 61/153,546, filed on Feb. 18, 2009.
(60) Provisional application No. 61/292,077, filed on Jan. 4, 2010.

(51) Int. Cl. B01L 3/02; B23P 11/00

(52) U.S. Cl. 422/100; 29/428

(57) ABSTRACT

The present invention provides a pipette device for moving or transferring micron quantities of fluid and cells, particularly oocytes/embryos, with a simplified pipette tip loading and unloading process. The present invention further provides a pipette device comprising a controller by which air pressure inside and outside of the controller can be intentionally balanced. Methods of manufacture and use of the pipette device of the present invention are also provided.

### CROSS REFERENCE OF RELATED APPLICATIONS

This application claims priority to U.S. Provisional Application Ser. No. 61/153,546, entitled “A New Pipette With Easy Disposable Pipette Tip Loading/Unloading,” filed Feb. 18, 2009, and U.S. Provisional Application Ser. No. 61/292,077, entitled “Safety Device for Pipette Controllers”, filed Jan. 4, 2010, the entire contents of these two applications are incorporated by reference herewith.

### FIELD OF THE INVENTION

The present invention relates to a pipette device, and method of manufacture and use thereof, to handle or rescue cells or embryos.

### BACKGROUND OF THE INVENTION

To precisely and quantitatively transfer small volume of fluid, pipettes are widely applied in routine laboratory practices. Sometimes, non-quantitative fluid transfer is also an important activity when the purpose is to move cells, oocytes or embryos from one culture dish to another, in which the exact liquid volume to be transferred is not very critical but depends on the need for moving cells or oocytes/embryos. A pipette used for fluid transfer is usually composed of a pressure controller (usually called a pipette) and a disposable pipette tip. A pipette works by creating a vacuum to draw up and dispense liquid. The negative and positive pressure in a pipette is mostly created by piston driven air displacement, occasionally by a screw-driven means.

A disposable pipette tip has two ways to be installed or loaded on a pipette. One is to cap a pipette tip to the distal end of a pipette, in which the pipette tip is conical shaped and has one end (proximal end) with an inner diameter larger than the outer diameter of the distal end of a pipette. Another way is to have a pipette tip made as a thin tube that has a continuously constant inner and outer diameter along its length, except at the most distal end. This type of pipette tip has much smaller internal air space (or volume) compared with the conical shaped pipette tip. A pipette associated with this kind of pipette tip has a metal plunger (or piston) that is thinner than the inner diameter of the pipette tip. In this design, the pipette needs a rubber sealer that is located inside the pipette for adapting the pipette tip. In addition, there is a collet (with internal threads) at the end of the pipette. The function of the collet is to provide pressure to the rubber sealer when it is tightened. During use, a pipette tip is first approached to the pipette to insert the metal plunger into the pipette tip, then the pipette tip passes the rubber sealer, finally the collet is tightened, which compresses the rubber sealer and seals the possible gap around the pipette tip to prevent air pressure leak. To unload the pipette tip, the collet needs to be loosened first, then one can remove the pipette.

A conical shaped pipette tip, in which a pipette tip is capped to the distal end of a pipette, is often applied to volumetric pipettes or graduated pipettes, but not suitable for some non-quantitative fluid transfer, especially when the purpose is to transfer cells or oocyte/embryos. It is very important to observe the movement of cells or oocyte/embryos inside a pipette tip during a transfer process. Using a conical shaped pipette tip makes the observation and control of cell movement difficult. The inner diameter of a conical shaped pipette tip varies at different positions and at most positions the inner diameter are very large compared with the continuously constant inner diameter pipette tip, which limits a cell or oocyte/embryo to travel only over a very short distance but also to move at different speed as the inner diameter changes.

When using a continuously constant inner diameter pipette tip, observation and control of the speed of movement of a cell or oocyte/embryo is easier. Besides, since the amount of liquid involved with transferring of a cell or oocyte/embryo is only several microns or less, the less internal air space, the better control can be achieved. A conical shaped pipette tip has a large internal air space that reduces the sensitivity of pressure control by a pipette.

The problems of using a continuously constant inner diameter pipette tip, for which one first has to insert a metal plunger into a pipette tip, then push the pipette tip through a rubber sealer, and finally tighten a collet, include: (1) loading and unloading a pipette tip can be over elaborate, complicated, and involves several steps as described above; (2) inserting a metal plunger into different pipette tips increases the possibility of cross contamination; (3) a pipette tip made from glass may easily break during loading/unloading and tightening of a collet; and (4) because a plunger moves back and forth inside a pipette tip, the pipette tip has to be made to have a sufficient length, which can be inconvenient or difficult to use.

Handling or transferring cellular structure, such as egg or embryo, is a common daily laboratory procedure. Micropipette tips used for this function are usually made of plastic or glass that carries a very small amount of solution or culture medium, such as less than 1-micron liter. Controlling to such small volume of solution requires a micropipette controller that creates a negative pressure for aspiration or delivers a positive pressure for expelling.

Air pressure leakage is one of the common dysfunctions for a micropipette controller. When it happens, capillary action sucks solution into a micropipette tip and retains cellular structure in the tip. The consequence is that the retained cells or embryos are at high risk of exposure to a non-optimal temperature and that the medium pH may quickly change to an unacceptable level. Quickly rescuing the retained cells or embryos becomes a challenge. A routine method includes removing the tip from the dysfunctional micropipette controller and loading it to another functional controller. However, pulling the micropipette tip may create more negative force inside the pipette tip, which causes the cells or embryos to be sucked deeper into the tip. In addition, even if the tip is successfully removed from the dysfunctional micropipette controller, loading the pipette tip (that has retained cells or embryos) to a functional controller presents another challenge. The capillary action causes the solution or cellular structure at the distal end of the pipette tip and the pressure inside the pipette tip to increase while loading the micropipette tip to a functional pipette controller. Thus, the increased pressure expels the retained cells or embryos from the tip resulting in cell and embryo loss.

With a functional micropipette controller, incidence can still happen. Every micropipette controller has a working range and it is not unusual that a micropipette controller reaches its extreme end of the working range, which means there is no room for a micropipette controller to create further positive air pressure, even though cells or embryos haven't been expelled out of the pipette tip. When this happens, a user has to remove the tip, then adjust the controller, and finally load the tip back to the controller. Cells or embryos are at a very high risk of getting lost during this process. When the user pulls the micropipette tip out of the controller, a negative force is created inside the micropipette tip that sucks the cells or embryos deeper inside the tip. When loading the micropipette tip back to the micropipette controller after adjusting the controller, a positive pressure is created that can expel the cells or embryos, which results in lost cells or embryos.

Some cell or embryo storage units have a very thin tubular structure. Loading cells or embryos into the storage unit, or retrieving stored cells or embryos out of the unit, may also require a micropipette controller. The challenge is that, after aspirating cells or embryos into the unit, the unit has to be unloaded from a micropipette controller and a negative pressure is created during the unloading process. Meanwhile, when retrieving cells or embryos from the unit, the storage unit has to be load to a micropipette controller first and a positive pressure is created inside the unit during this loading process. These increased or decreased air pressures created inside the unit may shift cell or embryo to an undesirable position inside the pipette tip and even causes loss of cells or embryos.

Therefore, there is a need to develop a pipette for moving or transferring micron quantities of fluid (even less than 1 micron) including its content, such as cells and oocytes/embryos, with a simplified pipette tip loading and unloading process. There is also a need to develop a mechanism for micropipette controllers by which air pressure inside and outside of the micropipette controller can be intentionally balanced.

### SUMMARY OF INVENTION

The present invention provides a pipette device comprising: a) a pipette controller having a proximal end, a distal end, a rigid tube extending from the distal end, and a manually engageable lever or actuating mechanism for creating positive and negative air pressure at the distal end of the rigid tube, b) a flexible sealing tube having a proximal end and a distal end, wherein the proximal end of the sealing tube creates an externally air-tight seal in communication with the distal end of the rigid tube, and c) a pipette tip having a proximal end and a distal end, wherein the proximal end of the pipette tip is removably engaged in externally air-tight communication within the distal end of the flexible sealing tube.

In certain embodiments, the proximal end of the sealing tube is a sleeve sealingly wrapped around the distal end of the rigid tube. In other embodiments, the proximal end of the sealing tube is sealingly inserted inside of the distal end of the rigid tube, and the proximal end of the pipette tip is removably engaged in externally air-tight communication within the distal end of the flexible sealing tube and the distal end of the rigid tube.

The present invention further provides that the pipette tip attached to the pipette device has a smooth edge on the proximal end and extends within the distal end of the flexible sealing tube and the distal end of the rigid tube. In certain embodiments, the pipette tip has a smooth edge not only on the proximal end, but also on the distal end. In some embodiments, the pipette tip used in the pipette device of the present invention is made of glass and could be disposable. However, any pipette tips used in the state of art are within the scope of the present invention.

Furthermore, the present invention provide micropipette controllers by which air pressure inside and outside of the micropipette controller can be intentionally balanced. To balance air pressure between inside and outside of a pipette controller of a pipette device is to create an airflow pathway and this pathway can be either at a closed state or an open state when needed. Thus, the present invention provides a pipette device that comprises a pipette controller that further comprises an external airflow pathway for air pressure balance inside and outside the pipette controller, and wherein the airflow pathway can be selectively closed or opened. In certain embodiments, the airflow pathway comprises holes that are open when holes at the distal end of the rigid tube and the proximal end of the sealing tube are aligned, and are closed when the holes are not aligned. The airflow pathway in the pipette controller can be located at the distal end of the rigid tube, the proximal end of the sealing tube, or both, and any places between the distal end of the micropipette controller and where the pressure is sealed inside a pipette controller.

In other embodiments, the airflow pathway comprises a plug or screw to selectively control the closed or opened airflow pathway. In the screw-type airflow pathway design, the distal end portion of the micropipette controller, i.e., from the distal end to the place where the pressure is sealed, is composed of two parts. These two parts are connected by screw mechanism with a sealer, such as an O-ring, to prevent pressure leakage. When needed, a user may loosen the screw to let air to pass (open status), otherwise tighten the screw for maintaining a closed condition.

Further, the present invention also provides an alternative design to create an air reservoir for a micropipette controller by which an additional forceful positive air pressure can be delivered to the controller. When cells or embryos are retained in a pipette tip, a user squeezes or compresses the air reservoir to create a positive air pressure to expel retained cells or embryos. Therefore, the present invention provides a pipette device that further comprises an air sac defining a pre-determined amount of air located within the distal or proximal end of the pipette controller of the pipette device to create positive or negative air pressure, or an air chamber within the distal end of the pipette controller to balance air pressure inside and outside the pipette controller. In certain embodiments, the air sac is attached to the proximal end of the pipette device that is capable of being squeezed or compressed to create a positive air pressure to expel retained cells or embryos.

Moreover, the present invention provides a pipette device comprising a lever (also referred to herein as an “actuating mechanism”) that can be a screw-type with a knob attached to the proximal end of the pipette controller of the pipette device and is capable of rotating a rod having threads and contained inside of the pipette controller to create positive or negative air pressure at the distal end of the rigid tube. Alternatively, the lever or actuating mechanism can be a piston-type with a plunger capable of moving back and forth inside the pipette controller to engage positive or negative air pressure at the distal end of the rigid tube. In the piston-type embodiments, the plunger is controlled by a spring and a thumb rest, and the pipette device further comprises a sealer to prevent air leaking around or between the plunger and the pipette controller. In certain piston-type embodiments, the pipette device further comprises an element between the spring and the sealer to further adjust the pressure created by the spring by passing the pressure to the sealer. The element further comprises an aspect in the middle to allow the plunger to move back and forth through the part easily. In certain embodiments, the aspect is a V-shaped hole with the larger surface face to the spring, allowing the plunger to move in.

The present invention also provides a pipette device comprising a) a pipette controller having a proximal end, a distal end, a rigid tube extending from the distal end, and a manually engageable lever or actuating mechanism for creating positive and negative air pressure at the distal end of the rigid tube, and b) a flexible sealing tube having a proximal end and a distal end, wherein the proximal end of the sealing tube creates an externally air-tight seal in communication with the distal end of the rigid tube.

A method of manufacturing the pipette device of present invention, and method of use of such pipette device for handling and rescuing cells, particularly oocytes and embryos, are also provided. As such, a method of manufacturing a pipette device comprising the steps of a) making a pipette controller having a proximal end, a distal end, a rigid tube extending from the distal end, and a manually engageable lever for creating positive and negative air pressure at the distal end of the rigid tube, b) making a flexible sealing tube having a proximal end and a distal end, wherein the proximal end of the sealing tube creates an externally air-tight seal in communication with the distal end of the rigid tube, and c) assembling the pipette controller and the flexible sealing tube together for adapting a pipette tip for use.

### BRIEF DESCRIPTION OF THE DRAWINGS

Reference will now be made to the accompanying drawings, which are not necessarily drawn to scale, and wherein:

FIG. 1 illustrates a perspective cross-sectional view of a sealing tube and a disposable pipette tip, according to one embodiment.

FIG. 2 illustrates a perspective cross-sectional view of a pipette tip loaded into a pipette device, according to one embodiment.

FIG. 3 illustrates a perspective cross-sectional view of a pipette tip loaded into a pipette device, according to one embodiment.

FIG. 4 illustrates a perspective cross-sectional view of a sealing tube and a disposable pipette tip, according to one embodiment.

FIG. 5 illustrates a perspective cross-sectional view of a pipette tip loaded into a pipette device, according to one embodiment.

FIG. 6 illustrates a perspective cross-sectional view of a pipette tip loaded into a pipette device, according to one embodiment.

FIG. 7 illustrates a perspective cross-sectional view of a pipette controller, according to one embodiment.

FIG. 8 illustrates a perspective cross-sectional view of a pipette controller, according to one embodiment.

FIG. 9 illustrates a perspective cross-sectional partial view of an open status of an airflow pathway, according to one embodiment: uniformed sleeve sealing tube.

FIG. 10 illustrates a perspective cross-sectional partial view of an open status of an airflow pathway, according to one embodiment: non-uniformed sleeve sealing tube.

FIG. 11 illustrates a perspective cross-sectional partial view of an airflow pathway including a plug, according to one embodiment.

FIG. 12 illustrates a perspective cross-sectional view of an airflow pathway comprising a plug and further in combination with a spring-like device, according to one embodiment.

FIGS. 13 (A and B) illustrates a perspective cross-sectional partial view of an airflow section of a pipette controller including a screw-type device to control airflow, according to one embodiment.

FIG. 14 illustrates a perspective cross-sectional view of a pipette controller including an air sac and/or air chamber, according to one embodiment.

FIG. 15 illustrates a perspective cross-sectional view of a pipette controller including an air sac and/or air chamber, according to one embodiment.

### DETAILED DESCRIPTION OF THE INVENTION

Embodiments of the present invention provide a pipette device for moving or transferring micron quantities of fluid (such as about 3-5 micron, or as low as less than 1 micron) including its contents, such as cells and oocytes/embryos, with a simplified pipette tip loading and unloading process. Embodiments of the present invention further provide a pipette device comprising a pipette controller by which air pressure inside and outside of the micropipette controller can be intentionally balanced.

In certain embodiments, the present invention provides a pipette device comprising: a) a pipette controller having a proximal end, a distal end, a rigid tube extending from the distal end, and a manually engageable lever or actuating mechanism for creating positive and negative air pressure at the distal end of the rigid tube, b) a flexible sealing tube having a proximal end and a distal end, wherein the proximal end of the sealing tube creates an externally air-tight seal in communication with the distal end of the rigid tube, and c) a pipette tip having a proximal end and a distal end, wherein the proximal end of the pipette tip is removably engaged in externally air-tight communication within the distal end of the flexible sealing tube. In other embodiments, the present invention provides a pipette device comprising: a) a pipette controller having a proximal end, a distal end, a rigid tube extending from the distal end, and a manually engageable lever or actuating mechanism for creating positive and negative air pressure at the distal end of the rigid tube, and b) a flexible sealing tube having a proximal end and a distal end, wherein the proximal end of the sealing tube creates an externally air-tight seal in communication with the distal end of the rigid tube.

A method of manufacturing the pipette device of present invention, and method of use of such pipette device for handling and rescuing cells, particularly oocytes and embryos are also provided. As such, a method of manufacturing a pipette device comprising the steps of a) making a pipette controller having a proximal end, a distal end, a rigid tube extending from the distal end, and a manually engageable lever or actuating mechanism for creating positive and negative air pressure at the distal end of the rigid tube, b) making a flexible sealing tube having a proximal end and a distal end, wherein the proximal end of the sealing tube creates an externally air-tight seal in communication with the distal end of the rigid tube, and c) assembling the pipette controller and the flexible sealing tube together for adapting a pipette tip for use.

The explanatory embodiments of the present invention are described below with reference to drawings.

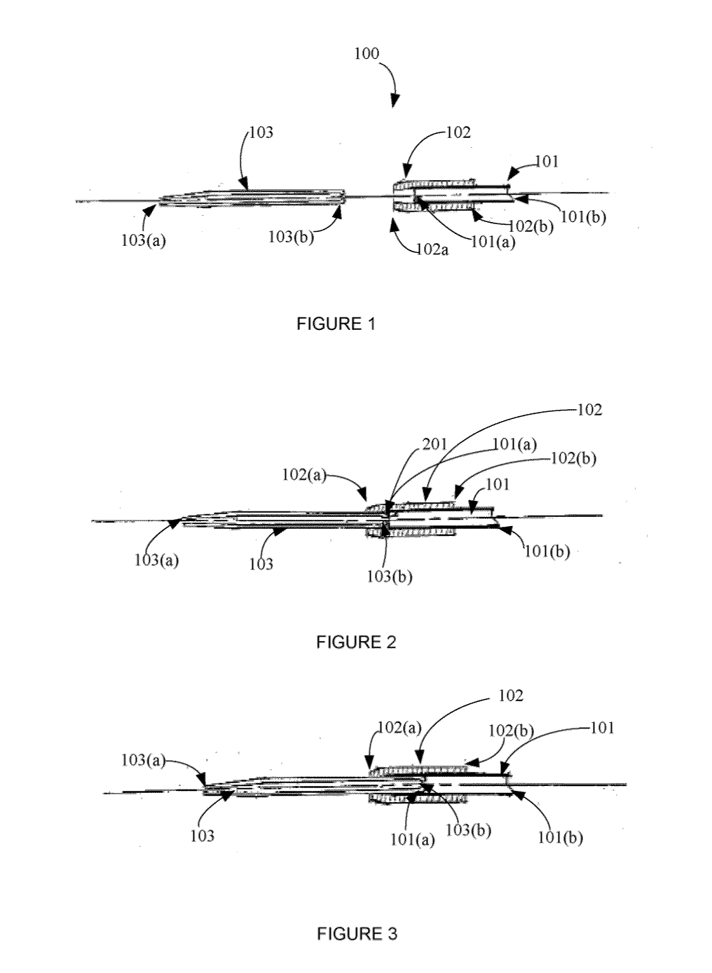

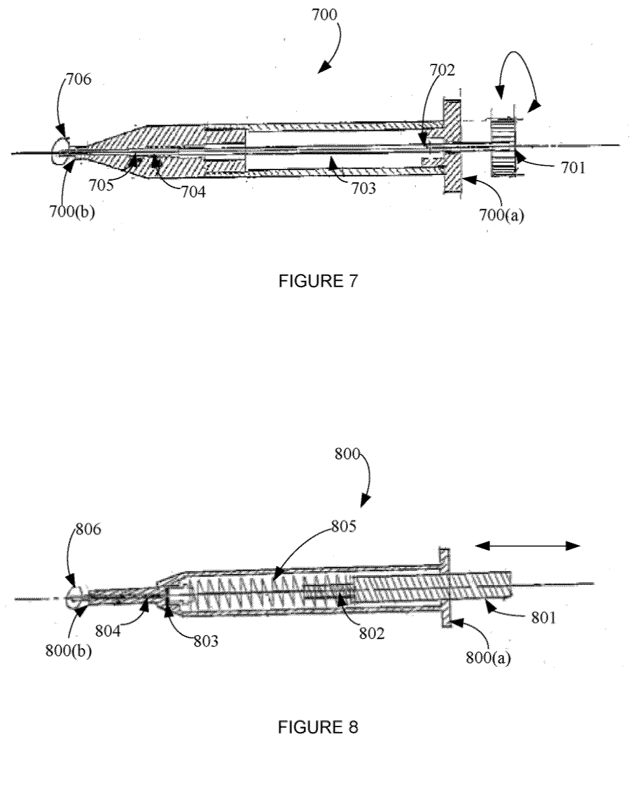

FIG. 1 is a perspective cross-sectional view showing one embodiment of a pipette device (100) that includes a soft sealing tube sleeve (102) sealingly wrapped around the distal end of a rigid/stiff tube (101), and a pipette tip (103) having its proximal end (103b) inserted into the distal end (102a) of the sealing tube sleeve (102) (not illustrated), which is described in more detail with reference to FIGS. 2 and 3. According to one embodiment, the pipette tip (103) may be disposable; though, in other embodiments, the pipette tip (103) may be re-usable. In one embodiment, the pipette tip (103) may be polished at one or both ends. The rigid tube (101) is a tube having a hollow passage formed therethrough and affixed to a distal end of a pipette controller, such as a pipette controller described with reference to FIG. 7 or 8. The pipette device (100) of this embodiment has a special design for simplified pipette tip (103) loading and unloading by combining the feature of the stiff or rigid tube (101) for stability and support with the features of the soft tube sleeve (102) for sealing around a pipette tip (103) and providing a certain extent of stability support, while also optionally permitting flexibility of the pipette tip (103) relative to the rigid tube (101) due to the material's partial flexibility. In certain embodiments, as shown, the tube sleeve (102) is self-sealing on the rigid tube (101) and the pipette tip (103) by friction and no ancillary tightening elements are used.

In some embodiments, a stiff tube (101) and a soft material-made tube sleeve (102) are designed to permit adjacent orientation of the stiff tube (101) relative to the tube sleeve (102). In certain embodiments, a soft material-made tube sleeve (102) may extend distally from the stiff tube (101), such as from approximately 1 mm to'approximately 20 mm, or from approximately 3 mm to approximately 10 mm in one embodiment. It is appreciated that the length the tube sleeve (102) extends from the stiff tube (101) may be greater or less than the illustrative lengths provided herein, and that the intended use and size of the overall device (100) may impact the length chosen.

FIG. 2 illustrates a perspective cross-sectional view of a pipette device (100) undergoing flexible loading, according to one embodiment. Flexible loading can be achieved by inserting the proximal end (103b) of a pipette tip (103) into the distal end (102a) of a soft sleeve sealing tube (102), which is sealingly wrapped around the distal end (101a) of a rigid or stiff tube (101). The proximal end (103b) of the pipette tip (103) approaches to the edge of the rigid or stiff tube (101) but is not inserted into the rigid or stiff tube (101). In this embodiment, the main function of the soft sleeve sealing tube (102) is to secure a disposable pipette tip (103) therein and hold it without permitting air to leak therefrom. While inserting the pipette tip (103) into the soft tube sleeve (102), the proximal end (103b) of the pipette tip (103) continues towards the stiff or rigid tube (101) until it is close to and/or abuts the distal end (101a) of the stiff tube (101). Upon insertion, the passageway of the pipette tip (103) and the passage way of the stiff tube (101) are in fluid communication to allow selectively withdrawing and/or expelling contents therein using a controller, such as is described in more detail with reference to FIGS. 7 and 8, for example.

Because the gap (201) between the distal end (101a) of the stiff tube (101) and the proximal end (103b) of the pipette tip (103) is so small, such as around or less than approximately 2 mm in one embodiment, and because the pipette tip (103) is very light in weight, the soft sealing tube sleeve (102) covering the gap (201) may be rigid enough to maintain the pipette tip (103) in a substantially straight orientation (or any other desired orientation) while still providing the pipette tip (103) a small degree of flexibility (e.g., “wobble”). In the flexible loading process, the pipette tip (103) is allowed to wobble within the tube sleeve (102) at least slightly due to the flexibility of the soft material-made sleeve tubing. The inner diameter of the soft sleeve (102) is configured to securely hold a pipette tip (103) tight enough to prevent air pressure leaks, but not too tight so as to allow pipette tip (103) loading and unloading.

FIG. 3, however, provides another method of loading a pipette tip, i.e., stable loading, according to one embodiment. In this embodiment, a pipette tip (103) is inserted into the soft sealing tube sleeve (102) that is sealingly wrapped around the distal end (101a) of the rigid or stiff tube (101), and the proximal end (103b) of the pipette tip (103) is inserted into the channel of the rigid or stiff tube (101) for a length, such as approximately 1 mm to approximately 10 mm inside the stiff tube (101), for example approximately 3 mm to approximately 5 mm in one embodiment. In this embodiment, the pipette rip (103) is not only secured by the soft tube sleeve (102), but the stiff tube (101) increases the pipette tip (103) stability and reduces wobble.

Compared to the stable loading, flexible loading is more suitable for a glass pipette tip, which overcomes the problem of tip break. However, any pipette tip available in the state of art, and/or later discovered that is suitable for handing cells, particularly oocytes and/or embryos, can be used with the pipette device embodiments of the present invention.

There are at least two ways to make a combination of a stiff tube and a soft material-made sealing tube. The first one is illustrated in FIGS. 1-3, wherein the soft material-made sealing tube sleeve (102) is positioned over the stiff tube like an outer sleeve. In certain embodiments, a short thin-wall stiff tube (101) extends distally from the body of a pipette controller device (examples of which are described in more detail with reference to FIGS. to 7 and 8), for instance, between approximately 1 mm to approximately 10 mm, such as approximately 3 mm to approximately 10 mm, according to one embodiment, from the distal end (101a) of the pipette controller. In these embodiments, the inner diameter of the stiff tube (101) may vary. For example, if a disposable pipette tip (103) is expected to be inserted into the stiff tube (101), the inner diameter of the stiff tube (101) is formed slightly larger than the outer diameter of a pipette tip (103) to provide a secure fit. As described above, the soft flexible material-made sealing tube sleeve (102) that acts like a cap is positioned over the stiff tube (101), and the distal end (102a) of the soft sealing tube sleeve (102) extends over the distal end (101a) of the stiff tube (101), for instance, between approximately 1 mm to approximately 10 mm, such as approximately 2 mm to approximately 5 mm, according to one embodiment, as shown in FIG. 1. The proximal segment (102b) of the soft sealing tube sleeve (102) is secured to the stiff tube (101) and seals it to prevent air from leaking between the soft tube sleeve (102) and the stiff tube (101).

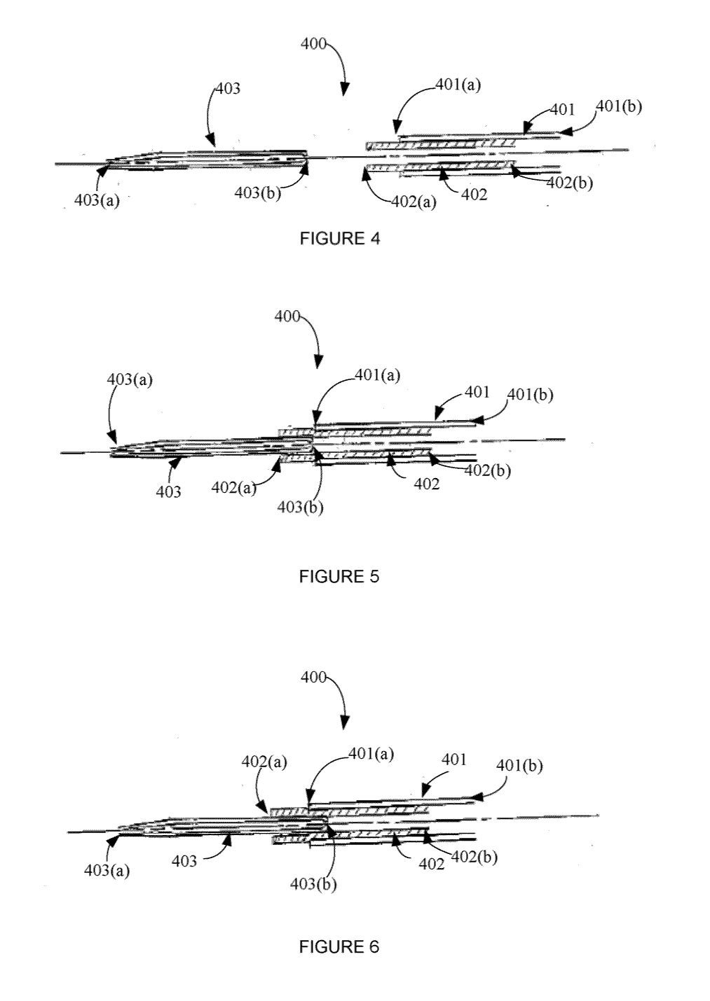

A second design for the combination of a stiff tube and a soft material-made sealing tube is illustrated by the example embodiments shown in FIGS. 4-6. According to this embodiment, the soft material-made sealing tube (402) is inserted inside the stiff tube (401), but extends distally from the stiff tube (401) between approximately 1 mm to approximately 10 mm, such as approximately 3 mm to approximately 5 mm, according to one embodiment, as is shown in FIG. 4. In these embodiments, the inner diameter of the stiff tube (401) is larger than the outer diameter of the soft material-made sealing tube (402). When loading, a pipette tip (403) is inserted into the distal end (402a) soft material-made sealing tube (402) in a direction towards the stiff tube (401). The pipette tip (403) can be inserted until its proximal end (403b) abuts or is proximate the edge of the distal end (401a) of the stiff tube (401) to provide some flexibility, i.e., flexible loading of a pipette device (400) as illustrated in FIG. 5. Otherwise, the pipette tip (403) can be inserted further, beyond the distal edge (401a) of the stiff tube (401) to achieve a more stable pipette tip loading, i.e., stable loading of a pipette device (400) as illustrated in FIG. 6.

In one embodiment, the soft material-made sealing tube (402) can be shorter than the stiff tube (401), such that the entire sealing tube (402) is within the stiff tube (401) without any portion extending distally therefrom. In this embodiment, only stable pipette tip loading can be achieved.

In certain embodiments, one or both ends of the pipette tip are polished or made smooth in order to make pipette tip insertion easy and to avoid damaging the soft material-made sealing tube or scratching the surface of a plastic culture dish. Methods of polishing the pipette tip, including a glass pipette tip, or other materials, are well known in the state of the art, including, but not limited to, heat polish.

The pipette tip loading and unloading designs provided by these embodiments can be used with any number of pipette controllers, such as a screw-driven pipette controller, or a pistol-driven pipette controller, which are illustrated by example in FIGS. 7 and 8, respectively. In either type, the pipette controllers have a very small air chamber, which is oriented proximate the distal end of the pipette device, in fluid communication with the channel formed through the stiff tube, such as is described with reference to FIGS. 1-6, above, and which allows sensitive pressure control due to a small internal air space.

One embodiment of a pipette controller is a screw-driven pipette controller, such as is illustrated in FIG. 7, and which may be referred to as a “gentletransfer pipette controller.” In certain embodiments, the screw-driven gentletransfer pipette controller includes a pipette controller body (700) having a proximal end (700a) and a distal end (700b), and forming at least one chamber therebetween. Extending from the distal end (700b) of the controller body (700) is a rigid or stiff tube (706), such as the rigid or stiff tubes described with reference to FIGS. 1-6 above, which are configured for fluid communication with a pipette tip attached thereto using a sealing tube.

Also included is a manually engageable actuating mechanism (701) (or “lever”) for actuating a pressure creating means which creates positive and negative air pressure within the rigid tube (706). For example, according to one embodiment, the actuating mechanism (701) may be a screw-type knob operably attached at the proximal end of the pipette controller body (700), which is capable of rotating a rod (703), which may be metal or any other suitable material, extending through the chamber of the pipette controller body (700). An air chamber (705) can also be located at the distal end (70b) of the pipette controller to sense and/or modulate the air pressure change.

Rotating the rod (703) moves a piston or other pressure creating means that causes positive or negative air pressure within the pipette controller body (700) and the rigid tube (706). For example, according to one embodiment, the pipette controller body (700) includes threads (704) formed on at least a portion of the internal surface (female part) which is adapted to threadably receive corresponding threads formed on the surface of a portion of the rod (703) (male part). When the rod (703) is turned in one direction, its distal portion threads into the threads (704) formed within the controller body (700), and a positive pressure is created. When the rod (703) is turned in the opposite direction, its distal portion threads out of the threads (704) formed within the controller body (700), and a negative pressure is created. Because the pressure is driven by the rotation of the rod (703) and its relative movement within the controller body (700), only a very small air volume change occurs during the rotation process, allowing the air pressure change to be achieved gradually, if desired. The actuating mechanism (701), such as a knob, is attached or otherwise included with the controller body (700) and can be turned to rotate the rod (703) clockwise or counter-clockwise. In certain embodiments, a small amount of grease can be applied between the threads of the rod (703) and the body (700) to prevent an air pressure leak. In some embodiments, a stopper (702) can be formed or otherwise integrated inside the pipette controller body (700) near the actuating mechanism (701), to prevent the actuating mechanism (701) from restrict movement of the mechanism, such as to prevent over-rotating a knob.

Another embodiment provides a pipette controller device that is piston-driven, as illustrated in FIG. 8, which may be referred to as an “easytransfer pipette device.” In certain embodiments, the piston-driven controller includes a pipette controller body (800) having a proximal end (800a) and a distal end (800b), and defining a chamber therein. The controller body (800) further includes a rigid tube (806) extending from the distal end (80b) of the controller body (800), such as the rigid or stiff tubes described with reference to FIGS. 1-6 above, which are configured for fluid communication with a pipette tip attached thereto using a sealing tube. A plunger (802) is operably provided within the chamber of the controller body (800), which is capable of moving back and forth therein to cause positive or negative air pressure within the rigid tube.

According to certain embodiments, the pipette controller further includes a spring (805) and a thumb rest (801) (or other actuating mechanism) in operable communication with the plunger (802) to provide control over the movement of the plunger (802). When the thumb rest (801) is pushed down to actuate the plunger (802) distally within the chamber of the controller body (800), a positive pressure is created therein. When the thumb rest (801) is released, the spring (805) causes the plunger (802) to retreat proximally, and a negative air pressure is created therein. According to one embodiment, a sealer (803) is applied to the plunger (802) and/or the chamber within the controller body (800) to prevent a pressure leak therein. The controller body (800) of this embodiment also includes an air chamber (804) formed at its distal end (800b), as described with reference to FIG. 7. It is appreciated that any other plunger or piston-driven element can be used to create negative and positive pressures within a device.

Since a pipette tip is only loaded at the distal end of the pipette device, there is no need to have an additional sealer to seal the pipette tip. However, according to one embodiment, one or more washer-like sealers may be included within the controller body (800) at one or more locations, including, but not limited to, around the plunger, at the periphery, and/or the bottom of the sealer. The advantage of the washer-like sealer(s) is to provide greater sealing throughout the controller body (800).

According to one embodiment, the present invention further provides a pipette controller that includes one or more external airflow pathways by which air pressure inside and outside of the pipette controller body can be selectively balanced, and wherein the airflow pathway can be selectively closed or opened. In certain embodiments, an airflow pathway can be configured as one or more holes formed through the rigid tube at/or near the distal end of the controller body, at or near the proximal end of the sealing tube, or both. In some embodiments, the airflow pathway is open when the one or more holes at the distal end of the rigid tube and the proximal end of the sealing tube are aligned, and closed when the one or more holes are not aligned.

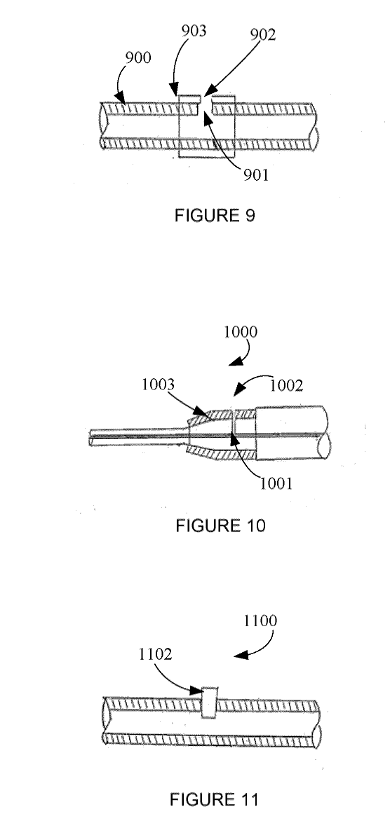

FIGS. 9 to 13 illustrate partial cross-sectional perspective views of exemplary embodiments of airflow pathways. FIG. 9 shows an open state of an airflow pathway having at least one hole (902) formed through sleeve sealing tube, such as a sealing tube sleeve (903) described with reference to FIGS. 1-6, and at least one hole (901) formed through a airflow section (900) of the pipette controller body, such as a pipette controller body described with reference to FIGS. 7-8. According to one embodiment, the airflow section (900) may be a separate attachment or extension adapted to the controller body, such as at or near the distal end of the controller body; or, in another embodiment, the airflow section (900) may simply designate a portion of the controller body and need not be a separate component. When the two holes (901) and (902) are aligned, air can flow in and out freely to balance air pressure inside the pipette controller, such as within an air chamber described with reference to FIGS. 7-8. In this embodiment, the holes (901) and (902) together serve to create an airflow pathway.

In certain embodiments, the sealing tube sleeve (903), which may be made of a soft, flexible material, including, but not limited to, silicone or rubber, has a consistent inner and outer diameter (uniformed sleeve sealing tube). The inner diameter of the sealing tube sleeve (903) fits the outer diameter of the pipette controller (proximate the hole) in a tight arrangement for sealing purposes, but loose or flexible enough to allow clockwise or counterclockwise turning and/or sliding in the proximal and distal directions. When the hole (902) on the sealing tube sleeve (903) is aligned with the hole (901) on the airflow section (900), the airflow pathway is in the open state and air can freely flow in and out of the pipette controller to balance the air pressure therein. In the open state, loading or unloading a pipette tip does not create any positive or negative air pressure inside the pipette tip. Turning the sealing tube sleeve (902) or moving the sealing tube sleeve (902) proximally or distally until two holes are not aligned closes the airflow pathway.

FIG. 10 illustrates an open state of an airflow pathway with aligned holes (1002), (1001) in a non-uniform sealing tube sleeve (1003) and the airflow section (1000) of the pipette controller body, respectively, according to one embodiment. In this embodiment, the non-uniform sealing tube sleeve (1003) is designed to tightly seal the distal end of the pipette controller body. This embodiment is similar to the uniform sealing tube sleeve illustrated in FIG. 9, except that the shape of the sealing tube sleeve (1003) is non-uniform to permit fitting with various shapes of a pipette controller distal portion, which includes at least one hole (1001) to create the airflow pathway.

FIG. 11 illustrates an airflow section (1100) of a controller body having a plug (1102) that can be inserted and removed to close and open an airflow pathway. The plug (1102) may be inserted from outside of the controller body, or from inside the controller body using an actuating means for moving the plug (1102).

Accordingly, as described above, an airflow pathway may be selectively opened or closed by any of the afore-mentioned means. When the airflow pathway is closed, the pipette controller is functional for aspirating or expelling solution with cells or embryos. When a micropipette controller is dysfunctional, such as leaking, a user switches the airflow pathway to an open status, then takes the pipette tip off from the dysfunctional micropipette controller safely. The user then adjusts a functional pipette controller at an open status and loads the pipette tip, after that switches the pathway to a closed condition for further performance.

When a micropipette controller reaches the end of its working range, but cells or embryos are still retained inside a pipette tip, a user just switches the airflow pathway to an open condition, after adjust the micropipette controller, the user switches the pathway back to its closed condition and then continues his/her work. In this way there is no need to pull out the pipette tip from the controller and load the tip back to the controller.

While handling a cell or embryo storage unit as described above, a user switches the airflow pathway to an open status after aspirate cells or embryos into the unit. Then the user unloads the unit from the controller without disturbing the air pressure inside the controller. To retrieve cells or embryos from the storage unit, a user switches the controller to an open condition while loading the unit to the controller. Then the user switches the controller to a closed status for expelling cells or embryos. Thus, there is no unwanted increased or decreased air pressure built in the micropipette controller.

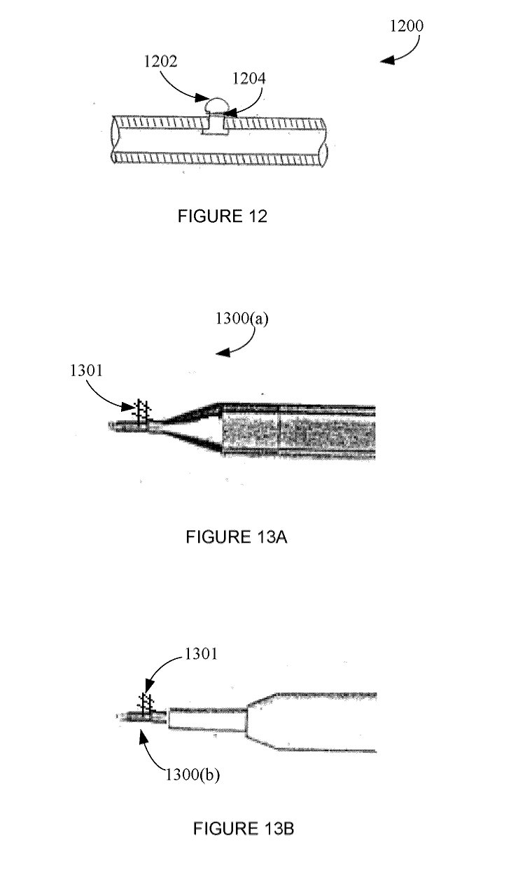

According to one embodiment, a plug (1202) may be further combined with a spring-like device (1204), which acts to bias the plug (1202) in an open (or closed) orientation, such as is illustrated in FIG. 12. According to one embodiment, the airflow pathway is held open by compressing the plug (1202) and the spring-like device (1204), and remains closed after releasing the pressure. The spring-like device (1204) acts to keep the plug (1202) sealing the hole in the airflow section (1200). When the spring-like device (1204) is pulled in a direction away from the hole, the airflow pathway is forced to an open position. After release, however, the spring-like device (1204) causes the plug (1202) to re-seal the hole.

FIGS. 13A and 13B further illustrate airflow sections (1300a) and (1300b), which include a screw-type device (1301) at the distal end of the pipette controller body. In one embodiment, the airflow sections (1300a) and (1300b) formed in the distal portion of a pipette controller body may be made from at least two parts operably connected via the screw-type device (1301), so as to bias one part against the other to control the airflow inside and outside the pipette controller. In the embodiment shown in FIG. 13A, the airflow section (1300a) may be formed in a shape more gradually integrating with the remainder of the controller body. In the embodiment shown in FIG. 13B, however, the airflow section (1300b) may be formed as a separate member affixed to the remainder of the controller body. In certain embodiments, a sealer, including, but not limited to, an O-ring, can be placed between the two parts. Any type of sealers known in the state of art or later discovered can be used in this embodiment. The airflow pathway can be selectively closed or opened by either tightening or losing the screw to control air flow from the pipette controller.

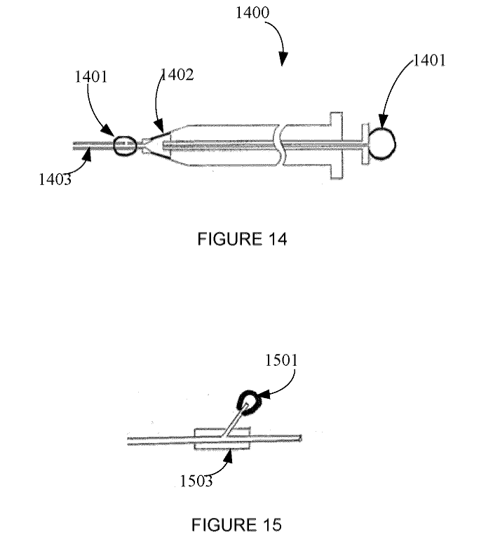

FIG. 14 illustrates a pipette controller body (1400) comprising an extended rigid tube (1403) at the distal end of the pipette controller body, in which an air sac (1401) and an air chamber (1402) are included. According to this embodiment, the air sac (1401) can be affixed to or otherwise positioned at or near the proximal end of the controller body (1400) and in connection with the air chamber (1402), and is oriented distal from the air sac, such as at or near the distal end of the controller body (1400). Alternatively, the air sac (1401) can be affixed to or otherwise positioned at or near the distal end of the controller body (1400), and when squeezed, create a positive air pressure to expel the cells. The air chamber (1402) is in fluid communication with the rigid or stiff tube (1403), which may be a rigid or stiff tube described with reference to FIGS. 1-6 to facilitate securing a pipette tip thereto. A positive air pressure is created when squeezing the air sac (1401) to expel solution or cellular structure from the pipette tip. In other embodiments, an air chamber (1402) may not be included.

Moreover, as shown in FIG. 15, an air sac (1501) may be affixed to or otherwise integrated with the rigid or stiff tube (1503) (or any other portion of the pipette controller body) and in fluid communication therewith, such as via a branching member. In this embodiment, the air sac (1503) may be squeezed in a similar manner to create a positive pressure within the stiff tube (1403).

Therefore, the present invention provides a novel pipette design that provides the following advantages: (1) one step for pipette tip loading; (2) no plunger is inserted into a pipette tip; (3) no rubber sealer is needed for sealing a pipette tip; (4) no additional tightening procedure (such as by a collet) after loading a pipette tip; (5) one step for pipette tip unloading; (6) reduced possibility of cross contamination carried by additional components to a pipette tip, as occurs with conventional devices; (7) a pipette tip can be made very sharp for simple, effective operation; (8) pipette tip can be loaded in two different states, a stable condition and a flexible condition, which significantly reduces the possibility of breaking a pipette tip when a glass pipette tip is used; and (9) a disposable pipette tip can be made in a shorter length, rather than for other piston-driven pipettes that require a pipette tip has to be made long enough to permit a piston to move back and forth. With respect to contamination, the present invention further provides that all the parts associated with air pressure controlling are contained inside the pipette controller, and no additional components or elements, such as a plunger, are needed to be inserted into a disposable pipette tip.

Methods of manufacturing and using the pipette device of the present invention for handling or rescuing a cell, particularly an oocyte and embryo, are also provided in the present invention.

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

What is claimed is:

1. A pipette device comprising:
a) a pipette controller having a proximal end, a distal end, a rigid tube extending from the distal end, and a manually engageable lever or actuating mechanism for creating positive and negative air pressure at the distal end of the rigid tube,
b) a flexible sealing tube having a proximal end and a distal end, wherein the proximal end of the sealing tube creates an externally air-tight seal in communication with the distal end of the rigid tube, and
c) a pipette tip having a proximal end and a distal end, wherein the proximal end of the pipette tip is removably engaged in externally air-tight communication within the distal end of the flexible sealing tube.

2. The pipette device of claim 1, wherein the proximal end of the sealing tube is a sleeve sealingly wrapped around the distal end of the rigid tube.

3. The pipette device of claim 1, wherein the proximal end of the sealing tube is sealingly inserted inside of the distal end of the rigid tube.

4. The pipette device of claim 1, wherein the proximal end of the pipette tip is removably engaged in externally air-tight communication within the distal end of the flexible sealing tube and the distal end of the rigid tube.

5. The pipette device of claim 1, wherein the pipette tip has a smooth edge on the proximal end, wherein the proximal end of the pipette tip extends within the distal end of the flexible sealing tube and the distal end of the rigid tube.

6. The pipette device of claim 1, wherein the pipette controller further comprises an external airflow pathway for air pressure balance inside and outside the pipette controller, and wherein the airflow pathway can be selectively closed or opened.

7. The pipette device of claim 6, wherein the airflow pathway is located at the distal end of the rigid tube, the proximal end of the sealing tube, or both.

8. The pipette device of Clam 7, wherein the airflow pathway is open when holes at the distal end of the rigid tube and the proximal end of the sealing tube are aligned, and when the airflow pathway is closed when the holes are not aligned.

9. The pipette device of claim 6, wherein the airflow pathway further comprises a plug to selectively control the closed or opened airflow pathway.

10. The pipette device of claim 6, wherein the airflow pathway further comprises a screw to selectively control the closed or opened airflow pathway.

11. The pipette device of claim 1, further comprising an air sac defining a pre-determined amount of air located within the distal end of the pipette controller to create positive or negative air pressure.

12. The pipette device of claim 11, wherein the air sac is affixed to or positioned at or near the proximal or distal end of the controller body to create a positive pressure within the rigid tube.

13. The pipette device of claim 1, further comprising an air chamber within the distal end of the pipette controller to balance air pressure inside and outside the pipette controller.

14. The pipette device of claim 1, where the lever is a screw-type with a knob attached to the proximal end of the pipette controller and is capable of rotating a rod with thread inside of the pipette controller to engage positive or negative air pressure at the distal end of the rigid tube.

15. The pipette device of claim 1, wherein the lever is a piston-type with a plunger capable of moving back and forth inside the pipette controller to engage positive or negative air pressure at the distal end of the rigid tube.

16. The pipette device of claim 15, wherein the plunger is controlled by a spring and a thumb rest, and further comprising a sealer to prevent air leak around or between the plunger and the pipette controller.

17. The pipette device of claim 16, further comprising a part between the spring and the sealer to further adjust a pressure created by the spring, wherein the part further comprises a means located in the middle of the part to allow plunger to move back and forth through the part easily.

18. The pipette device of claim 17, wherein the means is a V-shape hole.

19. A pipette device comprising:
a) a pipette controller having a proximal end, a distal end, a rigid tube extending from the distal end, and a manually engageable lever or actuating mechanism for creating positive and negative air pressure at the distal end of the rigid tube, and
b) a flexible sealing tube having a proximal end and a distal end, wherein the proximal end of the sealing tube creates an externally air-tight seal in communication with the distal end of the rigid tube.

20. A method of manufacturing or using the pipette device of claim 1, comprising
a) making a pipette controller having a proximal end, a distal end, a rigid tube extending from the distal end, and a manually engageable lever or actuating mechanism for creating positive and negative air pressure at the distal end of the rigid tube,
b) making a flexible sealing tube having a proximal end and a distal end, wherein the proximal end of the sealing tube creates an externally air-tight seal in communication with the distal end of the rigid tube, and
c) assembling the pipette controller and the flexible sealing tube together for adapting a pipette tip for use.
